(19) United States
(12) Patent Application Publication
(10) Pub. No.: US 2024/0389600 A1
(43) Pub. Date: Nov. 28, 2024

(54) ENHANCEMENT OF PEANUT (GROUNDNUT) SEED HEALTH BENEFITS BY BOOSTING RESVERATROL CONTENT

(71) Applicant: The United States of America, as represented by the Secretary of Agriculture, Washington, DC (US)

(72) Inventors: VICTOR SOBOLEV, ALBANY, GA (US); TRAVIS WALK, LEESBURG, GA (US); LISA L. DEAN, RALEIGH, NC (US)

(21) Appl. No.: 18/323,539

(22) Filed: May 25, 2023

(51) Int. Cl. A01N 59/00

(52) U.S. Cl. CPC A01N 59/00

(57) ABSTRACT

Described herein are economic, scalable, waste-free, and environment-friendly methods of boosting resveratrol concentration in peanut seeds to enhance this nutritionally important product as functional food for human consumption. Methods for improvement of animal feed with resveratrol-enriched split and damaged peanut seeds, skins, and embryos are described. Inexpensive materials and processing conditions for efficient methods are described.

### BACKGROUND OF THE INVENTION

The scientific literature contains numerous studies on how stilbenoids appear to exert various beneficial biological effects on human subjects such as cardio protection, neuroprotection, anti-diabetic properties, depigmentation, anti-inflammation, cancer prevention and treatment. These effects are thought to be mediated by several universal signaling pathways.

Resveratrol (1), trans-3,5,4′-trihydroxystilbene (FIG. 1b), a member of this class of compounds is produced naturally as a phytoalexin or as a phytoalexin precursor by several plants, including peanuts. Resveratrol concentration in sound peanut seeds (also referred to as kernels herein) is extremely low, however, in response to exogeneous stimuli, such as fungal invasion, treatment with oxidizers, slicing, chopping, or grinding, exposure to UV light or ultrasound, sufficiently hydrated peanut seeds are capable of producing substantially higher levels of resveratrol.

The health-beneficial properties of resveratrol have been researched in over 20,000 research papers published from 1997 to 2023. Resveratrol is described as a potent antioxidant, it may play a role in delaying aging, decrease the risk of cardiovascular diseases, inhibit initiation and progression of cancer, and reduce the risk of Alzheimer's disease. Resveratrol has a fairly low toxicity level and is reasonably well tolerated up to 5 grams per day. Pharmacological indications have led to food products containing resveratrol as a promising new beneficial ingredient. Resveratrol supplements are included in healthy lifestyle nutrition programs to reduce the risk of vascular and senile problems. Today more than 400 products containing resveratrol can be found on the market.

In addition to resveratrol, its derivatives such as polydatin (piceid) (3), δ-viniferin (2), arachidin-3 (4), arachidin-1 (5), and IPD (3′-isopentadienyl-3,5,4′-trihydroxystilbene) (8) (FIG. 1b), may be also produced by challenged peanut seeds. These compounds possess biological activities similar to those of trans-resveratrol and may be considered beneficial.

Utilizing the ability of abiotically challenged peanut plant to produce substantially higher levels of resveratrol, some research groups attempted to promote resveratrol production in seeds. Although, the 4-step laboratory procedure described by Chang et al. (J. Agric. Food Chem. 2006, 54, 10281), demonstrated high increase in resveratrol content, the final product could hardly be considered edible due to the advanced seed germination that may substantially change the composition and taste of the seeds. In addition, the lack of bacterial and fungal colonization was not assured; the seeds were sliced, which made their further suitable roasting impossible. Resurreccion et al. (U.S. Pat. No. 7,666,455) describes the enhancement of resveratrol content in peanut compositions by means of slicing hydrated seeds followed by their surface sterilization, sonication, and incubation of the sliced peanut seeds. This procedure is applicable only to seeds with reduced size (sliced, chopped, or ground) and provided only marginal increase of total resveratrol content to around 7 μg/g after 36 and 48 h of incubation.

Thus, there is a lack of substantial progress in the field of effective technology that efficiently provides peanut based nutritionally enhanced products bearing highly beneficial compounds like resveratrol and its related polyphenols.

### SUMMARY OF THE INVENTION

Provided herein are scalable, inexpensive, waste-free, and environment-friendly methods of boosting resveratrol concentration in commercial peanut seeds to enhance this nutritionally important product for human consumption. Methods are also described for the improvement of animal feed with resveratrol-enriched split and damaged seeds, skins, and embryos.

In one embodiment, a method is described for increasing resveratrol in peanut seeds, by incubating harvested hydrated peanut seeds for at least 24 hours in aqueous hydrogen peroxide (H₂O₂).

In one embodiment, a method is described for increasing resveratrol in peanut seeds, by incubating harvested hydrated peanut seeds for at least 24 hours in aqueous hydrogen peroxide wherein the H₂O₂ concentration is less than about 8 percent (8%).

In one embodiment, a method is described for increasing resveratrol in peanut seeds, by incubating harvested hydrated peanut seeds for at least 24 hours in aqueous hydrogen peroxide wherein the H₂O₂ concentration is less than about 8 percent wherein after incubation, and drying, the amount of resveratrol in the peanut seeds is at least about 50 μg resveratrol per g of dry seeds. In another embodiment the resveratrol concentration is at least 100 μg μg resveratrol per g of dry seeds.

In one embodiment, a method is described for increasing resveratrol in peanut seeds, by incubating harvested hydrated peanut seeds for at least 24 hours in aqueous hydrogen peroxide wherein the H₂O₂ concentration is a 1-4 percent hydrogen peroxide solution is employed.

A method of increasing resveratrol concentration in peanut seeds comprising the incubation with a liquid or aerosol of aqueous hydrogen peroxide for at least 24 hours.

In one embodiment, a resveratrol-enriched peanut seed wherein the resveratrol concentration is at least 50 micrograms/gram is described.

In one embodiment, a resveratrol-enriched peanut seed with a resveratrol concentration of at least 100 micrograms/gram is described.

### BRIEF DESCRIPTION OF THE DRAWINGS

The patent or application file contains at least one drawing or photograph executed in color. Copies of this patent or patent application publication with color drawing(s)/photographs will be provided by the Office upon request and payment of the necessary fee.

FIG. 1 is a graphical representation of resveratrol concentration in peanut seeds treated with hydrogen peroxide.

FIG. 2 shows structures of major peanut stilbenoids. 1, trans-resveratrol; 2, trans-8-viniferin; 3, trans-piceid; 4, trans-arachidin-3; 5, trans-arachidin-1; 8, trans-3′-isopentadienyl-3,5,4′-trihydroxystilbene (IPD).

FIG. 3 shows images of AUNPL-17 peanut seeds (a peanut cultivar developed by Auburn University, AL and National Peanut Research Laboratory, GA) after static incubation with 3% H₂O₂ and drying followed by treatment with Fast Blue B salt. The exposure time to H₂O₂ in hours (h) is indicated below each seed.

FIG. 4 shows Georgia 06G 2021 seeds; static incubation; 3% H₂O₂. Graph X axis shows the treatment time in hours. Y axis shows the amount of resveratrol in μg/g.

FIGS. 5 and 6 show typical, randomly picked 10 seeds of Georgia-06G (2021 harvest) after the static incubation with 3% H₂O₂ at 15° C. at various time points followed by air-drying and oven-roasting. After roasting, skins from the 10 seeds were removed (not shown in the photograph), the seeds were manually split, and embryos (shown above the split seeds in the photograph) were removed.

FIGS. 7 and 8 show typical, randomly picked 10 seeds of Georgia-06G (2021 harvest) after the static incubation with 3% H₂O₂ at 20° C. at various time points followed by air-drying and oven-roasting. After roasting, skins from the 10 seeds were removed (not shown in the photograph), the seeds were manually split, and embryos (shown above the split seeds in the photograph) were removed.

FIGS. 9 and 10 show typical, randomly picked 10 seeds of Georgia-06G (2021 harvest) after the static incubation with 3% H₂O₂ at 25° C. at various time points followed by air-drying and oven-roasting. After roasting, skins from the 10 seeds were removed (not shown in the photograph), the seeds were manually split, and embryos (shown above the split seeds in the photograph) were removed.

FIG. 11 and FIG. 12 panels A-G show maintaining H₂O₂ concentration within certain limits during the static incubation, provides higher resveratrol levels compared to a single volume of H₂O₂ charged at the beginning of incubation.

FIG. 13 shows production of resveratrol by Georgia-06G seeds (harvested in 2021) at 3 different experimental setups. In-shaker incubation gave significantly higher resveratrol accumulation than static and sonicator incubation. Each bar represents 8 replicates.

FIG. 14. graph represents results from the incubation/aeration (FIG. 22) of Georgia-06G seeds (2021 harvest) at 20° C. with 3% H₂O₂ that was replaced with fresh portions of the reagent every 24 h keeping the ratio of seed to liquid constant. Each bar represents 8 replicates. Typical oven-roasted seeds obtained after 72 h of such a treatment are shown below the graph.

FIG. 15. shows the comparison of different incubation techniques of Georgia-06G seeds harvested in 2020. Each bar represents 5 biological replicates.

FIG. 16. graph represents the results of the shaker-incubation of Georgia-06G seeds (2021 harvest) at 20° C. with 3% H₂O₂ that was replaced with fresh portions of the reagent every 24 h keeping the ratio of seed to liquid constant. Below the graph is a photograph of seeds after 72 h of incubation.

FIG. 17. shows resveratrol production under static incubation with 3% H₂O₂ of all the cultivars tested; the levels of resveratrol were not significantly different between the cultivars at any time of incubation. Each bar represents 7 biological replicates.

FIG. 18. shows comparison of resveratrol content in Georgia-06G (2021 harvest) seeds before and after roasting; shaker-incubation with 3% H₂O₂ at 20° C. Each bar represents 5 biological replicates. Georgia-06G (2021 harvest), shaker-incubated with 3% H₂O₂ at 20° C.

FIG. 19. shows influence of two techniques, oven-roasting and oil-frying, on resveratrol content in two cultivars tested. Seeds were treated with 3% H₂O₂ at 20° C. Each bar represents 4 biological replicates. samples, all the cultivars tested, were shaker-incubated with 3% H₂O₂ at 20° C.

FIG. 20 shows a setup to supply a constant flow of H₂O₂ fog/mist during incubation.

FIG. 21 shows a setup to supply a constant flow of H₂O₂ to avoid its exhaustion and to provide fogging with additional aeration and mechanical agitation by rotation of the reactor.

FIG. 22 shows a setup utilized for additional aeration of the seeds, and agitation of H₂O₂ for its efficient use.

FIG. 23 shows a fragment of a typical chromatogram of seed extract; seeds were treated with 3 portions of (new charge every 24 h) 3% H₂O₂ for 72 h at 20° C.

FIG. 24 shows a sample of blister-fried AUNPL-17 (2021 harvest) peanuts prepared by in-shaker incubation with 3% H₂O₂ at 20° C. for 48 h.

FIG. 25 shows peanut seed fractions that are routinely obtained during common post-harvest commercial processing of peanut pods and that are suitable for boosting resveratrol concentrations in these seed fractions. 1, Sound Mature Kernels; 2, Sound Splits; 3, Damaged or Discolored; 4, #1 or Other Kernels; 5, Splits or Cracked/Broken; 6, Skins; 7, Oil Stock.

### DETAILED DESCRIPTION

Described herein in various embodiments are efficient, scalable, economic, and waste-free, environment-friendly methods of boosting resveratrol concentration in peanut seeds to enhance this nutritionally important product as functional food for human consumption. Methods for improvement of animal feed with resveratrol-enriched split and damaged seeds, skins, and embryos are also described.

In one embodiment, a method employs incubation of peanuts with aqueous H₂O₂ (hydrogen peroxide) of at least 1% concentration at room temperature to provide a resveratrol concentration of at least 10 micrograms/gram. In other embodiments of the methods, the peanuts are hydrated in an aqueous medium or an antimicrobial medium before incubation. The antimicrobial medium can be a dilute, for example 0.1% hydrogen peroxide solution.

In one embodiment, a method employs a temperature in the range of 18-20° C. In other embodiments, temperatures below 18° C. provide desirable concentrations of resveratrol.

In one embodiment, a method employs incubation of peanuts with an aqueous 1-3% hydrogen peroxide at room temperature (20° C.) for 48-72 hours, producing consumer-ready whole seeds enriched with resveratrol in the range of 100-400 μg/g.

In some embodiments, peanut product of a method requires high-quality appearance of the seeds with no unusual discoloration or damage to embryo or cotyledons when compared to products available in the art. In other embodiments, high-quality appearance of the seeds is immaterial to quality of desired product as the product is used to make peanut butter and other commercial products with high concentrations of resveratrol. In one embodiment, consumer ready peanuts show characteristics like minimal discoloration from incubation and no visible embryo and cotyledon damage.

In another embodiment, a method for the preparation of “blister-fried” peanuts, the step of seed air-drying after the incubation step, is omitted, providing a method of production of a product even more affordable.

The methods described with a special reference to resveratrol content and seed quality after roasting, afford highly efficient and inexpensive procedures for added value to peanut as functional food.

In some embodiments of the methods, the peanut seed products may be offered as whole seeds or as cotyledons with embryos and skins removed.

Embodiments of the methods described herein can be used to increase resveratrol concentrations in splits, damaged seeds, and other alive peanut material that can be used as animal functional feed.

The methods produce peanut seeds with differing appearance and concentrations of resveratrol.

In various embodiments, after the incubation step, the resveratrol concentration enhanced peanut material is subject to one or more steps of roasting, boiling, blister frying, baking, seasoning, baking, or other process known in the art for food processing, consumption and preservation.

In one embodiment, seed hydration temperature ranges from 4 to 30° C. In one embodiment, seed hydration time ranges from 3 to 24 h (hours). In one embodiment, seed hydration media uses distilled water or 0.05 or 0.1% of H₂O₂. In one embodiment, incubation temperature ranges from 10 to 45° C. In one embodiment, incubation time ranges from 6 to 96 h (hours). In one embodiment, ratio of seeds to H₂O₂ solution ranges from 1:3 to 1:16 (w/v), respectively. In various embodiments, concentrations of hydrogen peroxide at the seed incubation step ranges from 0.05 to 8% under neutral, basic medium pH 7.5 to 11.5 (for example a 0.0375% solution of K₂CO₃ in 2% or 3% H₂O₂: pH=8.8 solution), and acidic conditions range from pH 2 to 6.9 (for example a 0.1% solution of CH₃COOH in 2% or 3% H₂O₂; pH=3.2 solution).

In one embodiment, a single load of hydrogen peroxide is used at the incubation step.

In another embodiment, a periodic change of H₂O₂ with the same volume of fresh portions of the reagent. In yet another embodiment a slow continuous flow of a suitable concentration of H₂O₂ is added to incubating peanuts to maintain a constant concentration of hydrogen peroxide. In yet another embodiment a spray of H₂O₂ is directed at incubating peanuts. In yet another embodiment a mist or fog of a suitable concentration of H₂O₂ is directed at a batch of incubating peanuts.

In one embodiment, the incubating peanut mixture is subjected to agitation. Agitation can be achieved by auger, blender, shaking, stirring, vibrating, tumbling, bubbling of reagent, air or inert gas (N₂, Ar, etc.) with O₂ or other means of agitation used in the art. In one embodiment of the process, ultrasonic energy is applied to the incubating material.

In one embodiment, a method is provided for increasing resveratrol concentration in peanut seeds comprising the steps of hydrating peanut seeds and incubating the peanut seeds in a mixture of aqueous hydrogen peroxide at room temperature for at least twelve hours.

In one embodiment, a method of increasing resveratrol concentration in peanut seeds by incubating hydrated peanut seeds in a mixture of between 0.1-8% percent aqueous hydrogen peroxide at a temperature between 12-45° C. for an incubation time of between 12-96 hours is described.

In another aspect, a method of increasing resveratrol concentration in peanut seeds by incubating hydrated seeds in a 1-4% hydrogen peroxide solution at temperature of 18-20° C. and incubation time of 48-72 hours is described.

In one aspect, after incubation, the peanut seeds are air-dried by treating the seeds at room temperature or at 35° C. for 12-15 hours. In other aspects, the peanuts are blister-fried, broiled, roasted, boiled, or processed in a step for consumption and or preservation as needed.

In one aspect peanut seeds are hydrated at seed hydration temperature of 4° C. to 30° C. and a seed hydration time from 3 to 24 h (hours).

In one aspect, peanut seeds are hydrated in seed hydration media selected from distilled water or 0.1% of H₂O₂.

In one aspect, the incubation of seeds is done without any stirring or agitation. In other aspects the incubation is done by agitating the incubating mixture.

In one aspect, the peanut seeds were incubated with the ratio of weight of seeds to H₂O₂ solution volume ranging from 1:3 to 1:20 (w/v), respectively.

In one aspect, a whole resveratrol-enriched peanut seed with at least about 50 μg resveratrol per g of dry seed is provided.

In one aspect, a whole resveratrol-enriched peanut seed with at least about 100 μg resveratrol per g of dry seed is provided.

In one aspect, a whole resveratrol-enriched peanut seed with at least about 150 μg resveratrol per g of dry seed is provided.

In one aspect, a whole resveratrol-enriched peanut seed with at least about 200 μg resveratrol per g of dry seed is provided.

In one aspect, a whole resveratrol-enriched peanut seed with at least about 250 μg resveratrol per g of dry seed is provided.

In one aspect, a whole resveratrol-enriched peanut seed with at least about 300 μg resveratrol per g of dry seed is provided.

In one aspect, a whole resveratrol-enriched peanut seed with at least about 350 μg resveratrol per g of dry seed is provided.

In one aspect, a whole resveratrol-enriched peanut seed with at least about 400 μg resveratrol per g of dry seed is provided.

In one aspect, a whole resveratrol-enriched peanut seed with at least about 450 μg resveratrol per g of dry seed is provided.

In one aspect, a whole resveratrol-enriched peanut seed with at least about 500 μg resveratrol per g of dry seed is provided.

In one aspect, a whole resveratrol-enriched peanut seed with at least about 550 μg resveratrol per g of dry seed is provided.

In one aspect, a whole resveratrol-enriched peanut seed with at least about 600 μg resveratrol per g of dry seed is provided.

In one aspect, a whole resveratrol-enriched peanut seed with at least about 50 μg resveratrol per g of dry seed, wherein the peanut seed is not size reduced or visually showing damage to the embryo or cotyledons.

In one aspect, a whole resveratrol-enriched peanut seed with at least about 100 μg resveratrol per g of dry seed, wherein the peanut seed is not size reduced or visually showing damage to the embryo or cotyledons.

In one aspect, a whole resveratrol-enriched peanut seed with at least about 150 μg resveratrol per g of dry seed, wherein the peanut seed is not size reduced or visually showing damage to the embryo or cotyledons.

In one aspect, a whole resveratrol-enriched peanut seed with at least about 200 μg resveratrol per g of dry seed, wherein the peanut seed is not size reduced or visually showing damage to the embryo or cotyledons.

In one aspect, a whole resveratrol-enriched peanut seed with at least about 250 μg resveratrol per g of dry seed, wherein the peanut seed is not size reduced or visually showing damage to the embryo or cotyledons.

In one aspect, a whole resveratrol-enriched peanut seed with at least about 300 μg resveratrol per g of dry seed, wherein the peanut seed is not size reduced or visually showing damage to the embryo or cotyledons.

In one aspect, a whole resveratrol-enriched peanut seed with at least about 350 μg resveratrol per g of dry seed, wherein the peanut seed is not size reduced or visually showing damage to the embryo or cotyledons.

In one aspect, a whole resveratrol-enriched peanut seed with at least about 400 μg resveratrol per g of dry seed, wherein the peanut seed is not size reduced or visually showing damage to the embryo or cotyledons.

In one aspect, a whole resveratrol-enriched peanut seed with at least about 450 μg resveratrol per g of dry seed, wherein the peanut seed is not size reduced or visually showing damage to the embryo or cotyledons.

In one aspect, a whole resveratrol-enriched peanut seed with at least about 500 μg resveratrol per g of dry seed, wherein the peanut seed is not size reduced or visually showing damage to the embryo or cotyledons.

In one aspect, a whole resveratrol-enriched peanut seed with at least about 550 μg resveratrol per g of dry seed, wherein the peanut seed is not size reduced or visually showing damage to the embryo or cotyledons.

In one aspect, a whole resveratrol-enriched peanut seed with at least about 600 μg resveratrol per g of dry seed, wherein the peanut seed is not size reduced or visually showing damage to the embryo or cotyledons.

In one aspect, split resveratrol-enriched peanut seed with at least about 100 μg resveratrol per gram of dry seed, wherein the peanut seed is not size reduced or stressed.

In one aspect, an edible snack peanut raw or cooked comprising a whole or split seed or peanut seed with a mixture of resveratrol; trans-viniferin, trans-arachidin-3 and trans-arachidin-1 wherein the resveratrol concentration is at least 50 micrograms/gram is described.

In another aspect, the edible snack peanut raw or cooked having a resveratrol concentration of at least 100 micrograms/gram. In yet another aspect, the peanut has a resveratrol concentration of at least 300 micrograms/gram.

In one embodiment, a method employs incubation of peanuts with aqueous 1-3% hydrogen peroxide at room temperature to provide peanuts with a resveratrol concentration of at least 10 micrograms/gram wherein incubation time is at least 8 hours. In another embodiment, the incubation time is at least 10 hours. In another embodiment, the incubation time is at least 12 hours. In another embodiment, the incubation time is at least 14 hours. In another embodiment, the incubation time is at least 20 hours. In another embodiment, the incubation time is at least 24 hours. In another embodiment, the incubation time is at least 48 hours. In another embodiment, the incubation time is at least 72 hours. In another embodiment, the incubation time is at least 96 hours. In another embodiment, the incubation time is at least 120 hours.

In one embodiment, a method employs incubation of peanuts with aqueous 1-3% hydrogen peroxide at room temperature to provide peanuts with a resveratrol concentration of at least 20 micrograms/gram wherein incubation time is at least 8 hours. In another embodiment, the incubation time is at least 10 hours. In another embodiment, the incubation time is at least 12 hours. In another embodiment, the incubation time is at least 14 hours. In another embodiment, the incubation time is at least 20 hours. In another embodiment, the incubation time is at least 24 hours. In another embodiment, the incubation time is at least 48 hours. In another embodiment, the incubation time is at least 72 hours. In another embodiment, the incubation time is at least 96 hours. In another embodiment, the incubation time is at least 120 hours.

In one embodiment, a method employs incubation of peanuts with aqueous 1-3% hydrogen peroxide at room temperature to provide peanuts with a resveratrol concentration of at least 60 micrograms/gram wherein incubation time is at least 8 hours. In another embodiment, the incubation time is at least 10 hours. In another embodiment, the incubation time is at least 12 hours. In another embodiment, the incubation time is at least 14 hours. In another embodiment, the incubation time is at least 20 hours. In another embodiment, the incubation time is at least 24 hours. In another embodiment, the incubation time is at least 48 hours. In another embodiment, the incubation time is at least 72 hours. In another embodiment, the incubation time is at least 96 hours. In another embodiment, the incubation time is at least 120 hours.

In one embodiment, a method employs incubation of peanuts with aqueous 1-3% hydrogen peroxide at room temperature provide peanuts with a resveratrol concentration of at least 120 micrograms/gram wherein incubation time is at least 8 hours. In another embodiment, the incubation time is at least 10 hours. In another embodiment, the incubation time is at least 12 hours. In another embodiment, the incubation time is at least 14 hours. In another embodiment, the incubation time is at least 20 hours. In another embodiment, the incubation time is at least 24 hours. In another embodiment, the incubation time is at least 48 hours. In another embodiment, the incubation time is at least 72 hours. In another embodiment, the incubation time is at least 96 hours. In another embodiment, the incubation time is at least 120 hours.

In other aspects, embodiments of the methods can used for the purpose of production of peanut butter and drinkable peanut powder (powder that is used to enhance the flavor of the beverage such as smoothies and other food products, fortification of cookies and food supplements with resveratrol-enriched skins. Methods described herein in their various aspects can be essentially waste-free, environment-friendly wherein the only by-product is microorganism-free water and has an appreciable commercial potential.

The methods described here may be applied to peanuts of any market type, including Runner, Virginia, Spanish, Valencia and other types known in the art. Peanut seeds grow within a pod. The oblong pods have rounded ends and are most commonly 25-50 mm (1-2 inches) long with two or three seeds; the pods are contracted between the seeds and have a thin, netted, spongy shell. The seeds vary from oblong to nearly round and have a papery seed coat that ranges in color from whitish to dark purple.

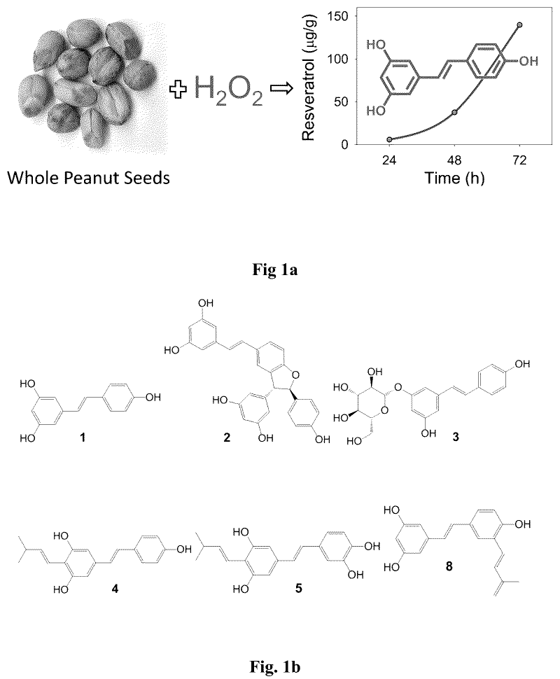

Turning to the drawings, FIG. 1 is a graphical representation of resveratrol concentration in peanut seeds.

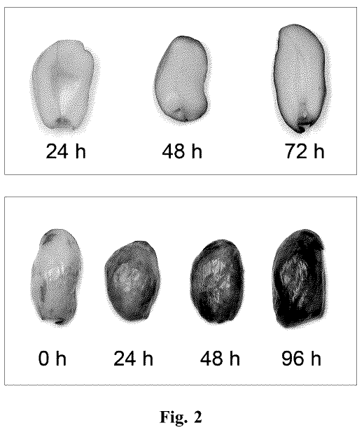

FIG. 2 shows structures of major peanut stilbenoids. 1, trans-resveratrol; 2, trans-8-viniferin; 3, trans-piceid; 4, trans-arachidin-3; 5, trans-arachidin-1; 8, trans-3′-isopentadienyl-3,5,4′-trihydroxystilbene (IPD).

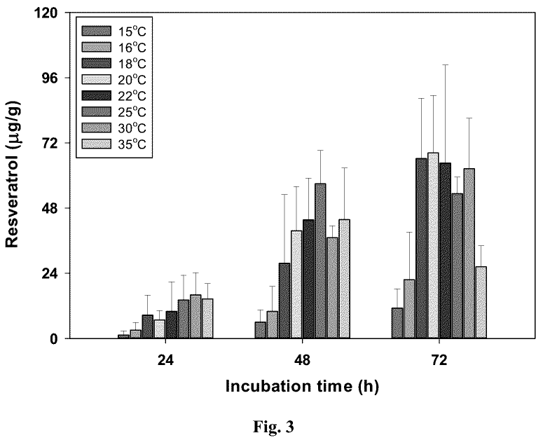

FIG. 3 shows AUNPL-17 images of peanut seeds after static incubation with 3% H₂O₂ and drying followed by treatment with Fast Blue B salt. The intensity of the brownish-purple coloration is proportional to the concentration of phenolic compounds. Cross section (upper row) and the outer surface of seeds (lower row) demonstrate that resveratrol and other phenolic compounds are biosynthesized and concentrated in the outer surface of seeds; the degree of coloration increases with the incubation time. The exposure time in hours (h) is indicated below each seed.

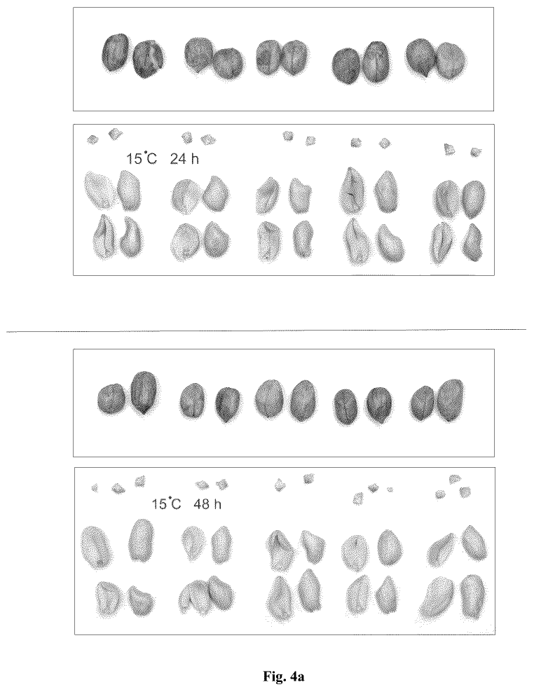

FIG. 4 shows Georgia 06G 2021 seeds; static incubation; 3% H₂O₂.

Concentrations of resveratrol are relatively low, and SD is moderately high due to uneven supply of H₂O₂ to seeds and its local exhaustion due to the lack of active liquid agitation. This figure shows a graph of the amount of resveratrol in peanuts after treatment for different amounts of time. X axis shows the treatment time in hours. Y axis shows the amount of resveratrol in μg/g.

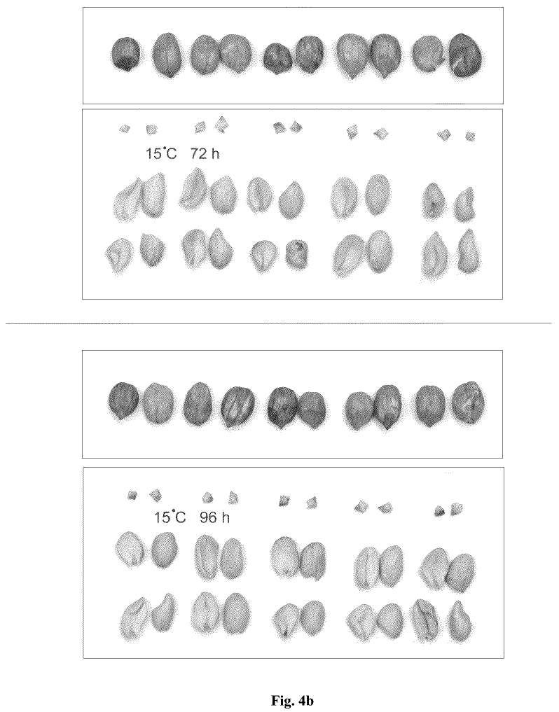

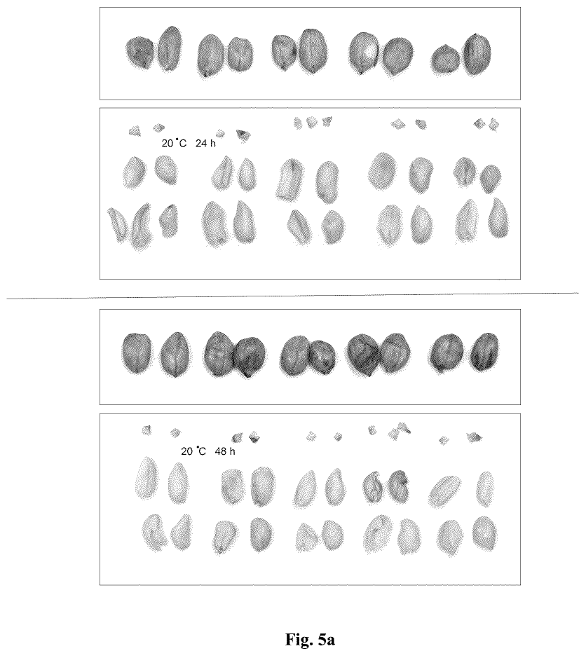

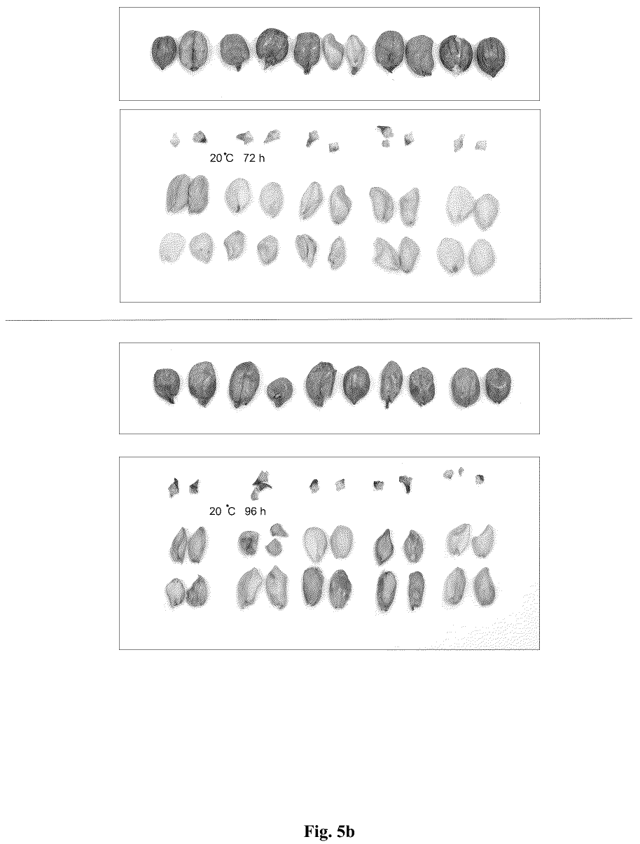

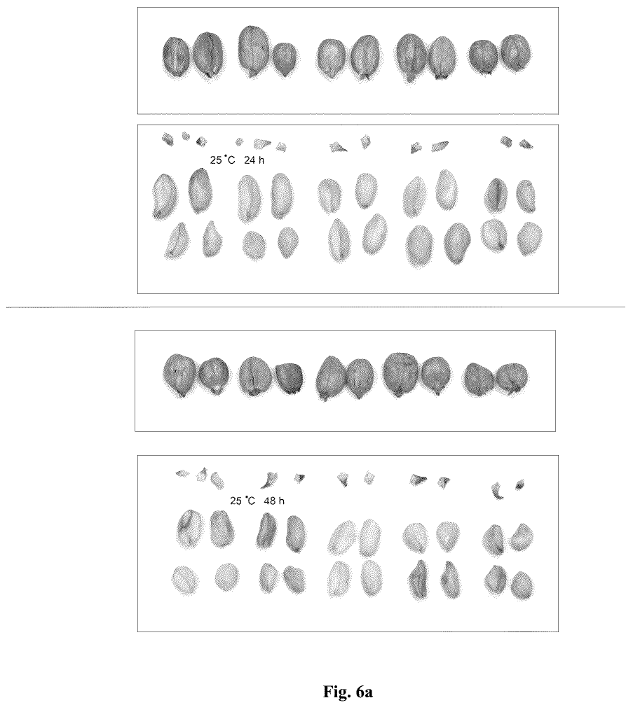

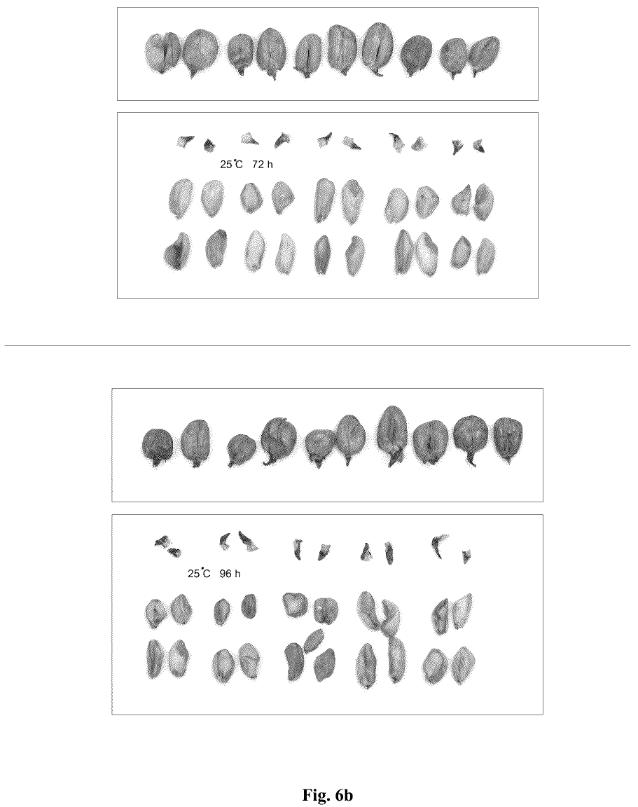

FIGS. 5 and 6 show typical, randomly picked seeds of Georgia-06G (2021 harvest) after the static incubation with 3% H₂O₂ at 15° C. followed by air-drying and oven-roasting. All seeds, even after 96 h of incubation, look like traditionally roasted control seeds (not shown) except for slight coloration of the embryos. The 20-50 micrograms/gram (μg/g) levels of resveratrol after 72 and 96 h of incubation may be appreciably acceptable in some applications considering the high-quality appearance of the seeds.

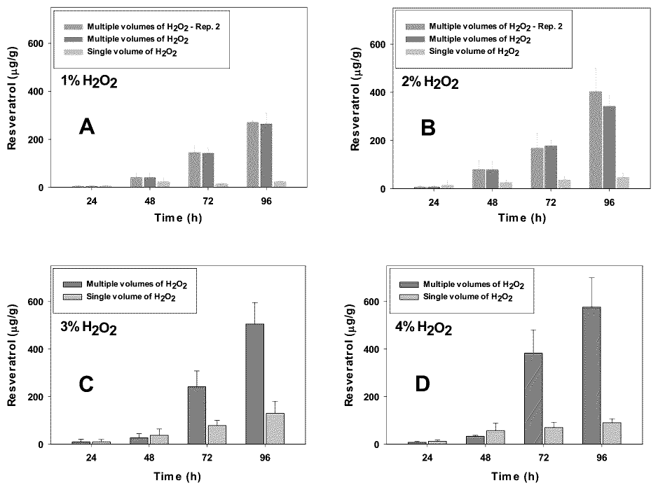

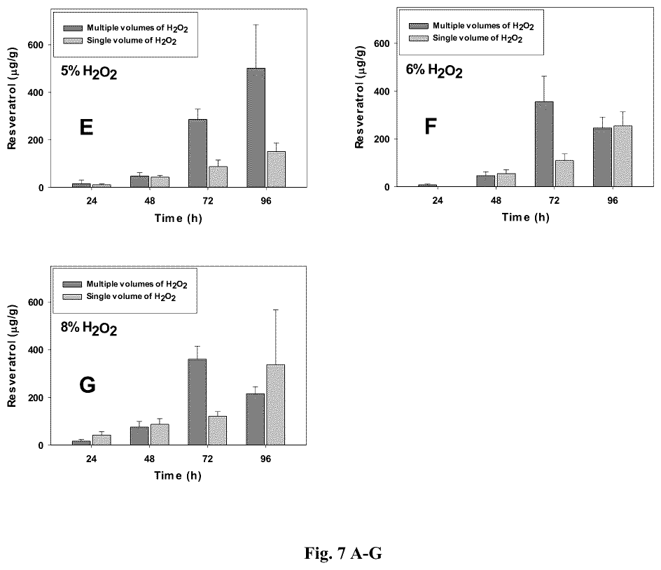

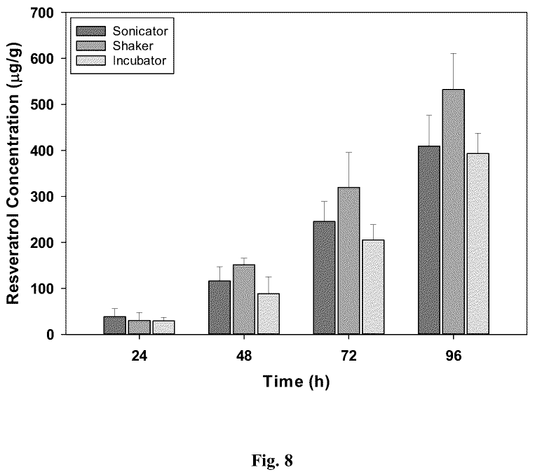

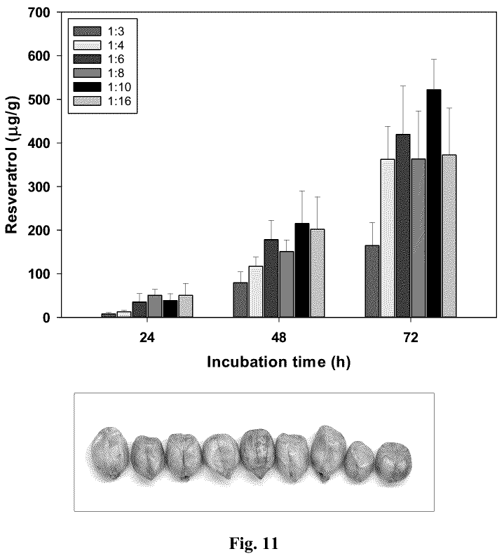

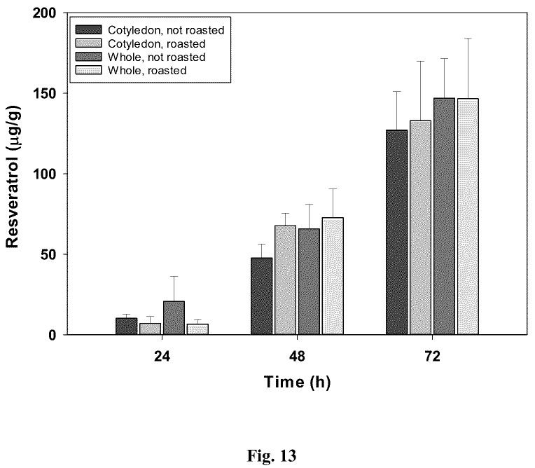

FIGS. 7 and 8 shows typical, randomly picked seeds of Georgia-06G (2021 harvest) after the static incubation with 3% H₂O₂ at 20° C. followed by air-drying and oven-roasting. Seeds, incubated for 24, and 48 h, have acceptable appearance and may be used in many applications as whole or split; seeds after 72 h of incubation can be used as splits with skins and embryos removed. Forty-eight and 72-h incubation provide satisfactory resveratrol content at 50-100 μg/g (FIG. 11C) and 100-200 μg/g levels even at lower, 2% H₂O₂ concentration (FIG. 13). Peanuts, incubated for 96 h are acceptable for mixed feed formulations. Not only lower incubation temperatures resulted in higher quality peanuts with acceptable level of resveratrol, but these temperatures also favored the production of this desirable component vs. production of other stilbenoids (FIG. 23).

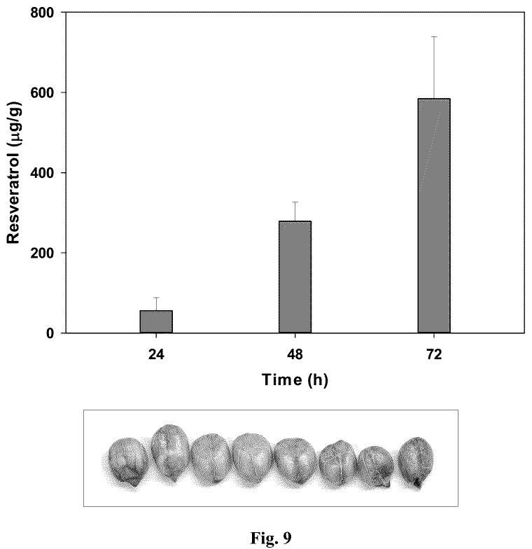

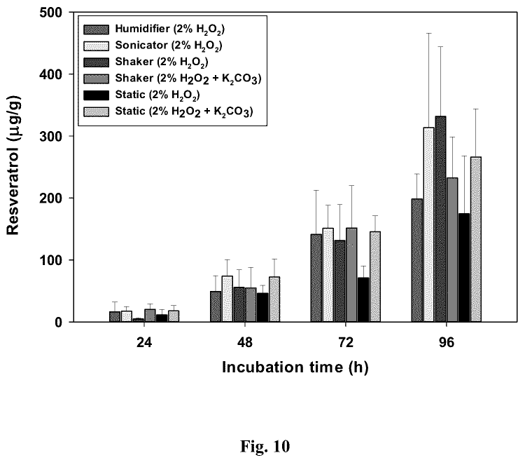

FIGS. 9 and 10 show typical, randomly picked seeds of Georgia-06G (2021 harvest) after the static incubation with 3% H₂O₂ at 25° C. followed by air-drying and oven-roasting. Only seeds that were incubated up to 48 h are visually acceptable. The seeds incubated at 48 and 72 h seem to be acceptable only as an ingredient in a nutritious mixture, peanut butter, or in mixed feeds; incubated for 96 h seeds, also could be used in mixed feeds.

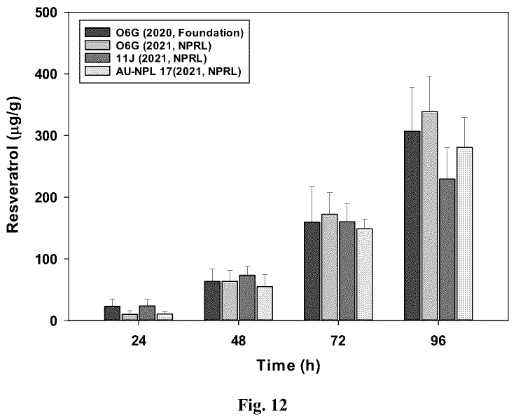

FIGS. 11 and 12 panel A through G show maintaining H₂O₂ concentration within certain limits during the static incubation, provides higher resveratrol levels compared to a single volume of H₂O₂ charged at the beginning of incubation. Concentrations of H₂O₂ above 4% damage seeds, and overall production of resveratrol drops, particularly, after 72 h of incubation. Therefore, the optimal concentration of H₂O₂ is between 1 and 4%. These experiments were performed at 20° C.; the ratio of seeds to H₂O₂ was 1:6 w/v. Each bar represents 8 replicates of Georgia-06G seeds harvested in 2021.

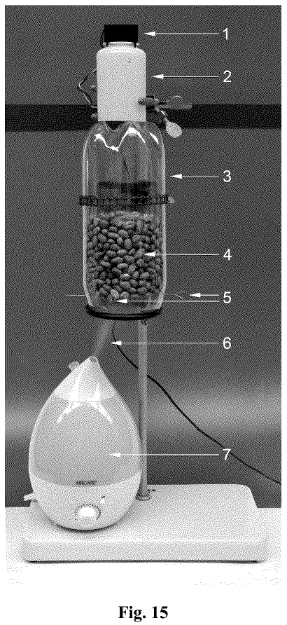

FIG. 13 shows each bar represents 8 replicates of Georgia-06G seeds harvested in 2021. In-shaker incubation gave significantly higher resveratrol accumulation than static and sonicator incubation exceeding 300 μg/g of seed dry weight after 72 h. Setup with the seed sonication gave insignificantly higher resveratrol levels compared with the static setup. In all the experiments 2% H₂O₂ was used at 20° C. It should be noted that even the static incubation provided higher resveratrol concentrations in the seeds of 2021 harvest compared to seeds of 2020 harvest (FIG. 15) at all sampling times and all incubation techniques used.

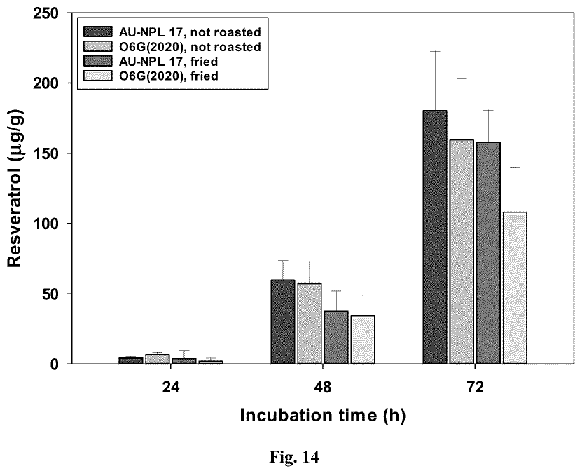

FIG. 14 graph represents results from the incubation/aeration (FIG. 22) of Georgia-06G seeds (2021 harvest) with 3% H₂O₂ that was replaced with fresh portions of the reagent every 24 h keeping the ratio of seed to liquid constant. The seed to liquid ratio was 1:8, w/v, and the incubation temperature was 20° C. Each bar represents 8 replicates. This aeration technique allowed to obtain results with resveratrol concentration reaching 600 μg/g at 72 h; the seeds were not noticeably germinated and had acceptable appearance as seen from the photograph below the graph.

FIG. 15. graph shows each bar represents 8 replicates of Georgia-06G seeds harvested in 2020. In all these earlier experiments 2% H₂O₂ was used at 20° C. All the setups tested were superior to the static incubation. However, in terms of resveratrol production, static incubation under mild basic conditions was in a par with others and was significantly higher than the static setup under neutral conditions. In contrast, moderate acidic conditions almost completely blocked resveratrol production.

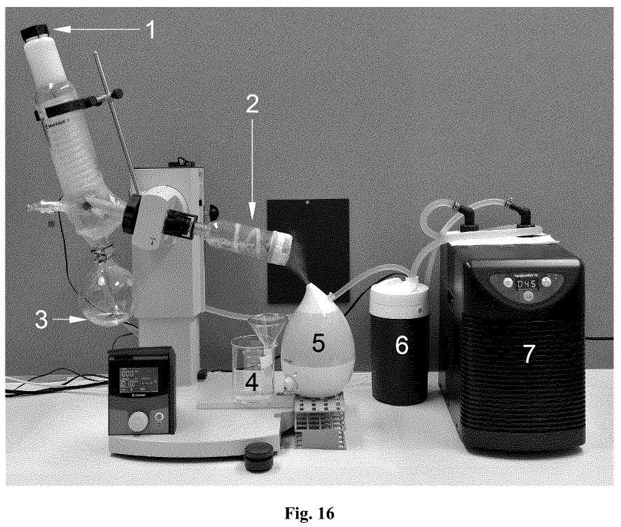

FIG. 16. graph represents the results of the shaker-incubation of Georgia-06G seeds (2021 harvest) at 20° C. with 3% H₂O₂ that was replaced with fresh portions of the reagent every 24 h keeping the ratio of seed to liquid constant. The seed to liquid ratio of 1:3, w/v did not demonstrate desirable results due to the exhaustion of the reagent. However, 1:4, w/v ratio provided acceptable results with resveratrol concentration reaching 400 μg/g at 72 h. In addition, the seeds were not noticeably germinated and had acceptable appearance as seen from the photograph below the graph. Ratios higher than 1:6, w/v did not lead to significant increase of resveratrol levels, and some seeds showed the signs of embryo and cotyledon damage.

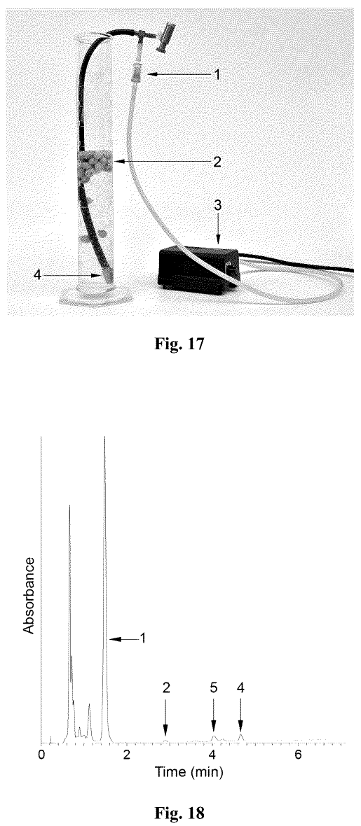

FIG. 17. shows under static incubation with 3% H₂O₂ of all the cultivars tested, the levels of resveratrol were not significantly different within 24-72 h of incubation; at 96 h the least stored Georgia-06G (2020 harvest) showed marginally higher results compared to Georgia-06G harvested in 2020.

FIG. 18. shows Georgia-06G (2021 harvest), shaker-incubated with 3% H₂O₂ at 20° C. Oven-roasting did not significantly affect resveratrol content in whole seeds and seed parts.

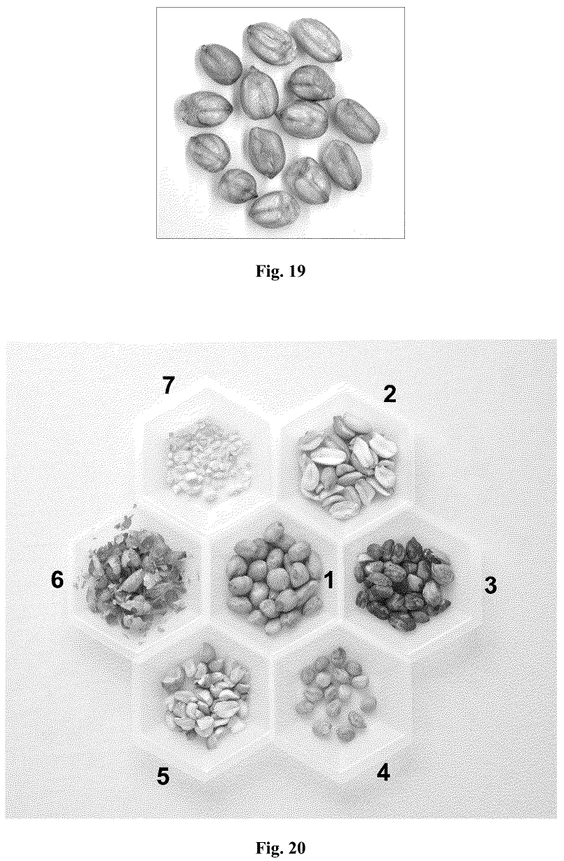

FIG. 19. shows samples, all the cultivars tested, were shaker-incubated with 3% H₂O₂ at 20° C. In contrast to oven-roasted seeds, resveratrol content was decreased in oil-fried “blister” seeds (FIG. 19). In some cases, the difference was significant between selected cultivars.

FIG. 20 shows a setup to supply a constant flow of H₂O₂ fog/mist during incubation. FIG. 20 shows a setup for static fogging. 1, computer fan, attached with screws to a plastic bottle with cut bottom; this construction is secured with a laboratory clamp on top of the reactor, which was made from a carbonated water bottle; reactor 3 has a circular cut at the top, so that bottle 2 could be moved up and down inside that circle to partially block the four triangular holes to allow air flow from outside and regulate seed aeration and flow rate of H₂O₂ fog/mist entering the reactor. 4, peanut seeds. 5, pins holding a stainless-steel mesh. 6, H₂O₂ fog/mist blown from the fogger. 7, commercial fogger charged with 2% H₂O₂.

FIG. 21 shows a setup to supply a constant flow of H₂O₂ to avoid its exhaustion and to provide fogging with additional aeration and mechanical agitation by rotation of the reactor. FIG. 21 shows a setup for dynamic fogging. 1, computer fan, attached with screws to a plastic bottle with cut bottom; this construction is secured and sealed on top of the condenser with a custom-cut foam ring. 2, small-size reactor, custom-made from a water bottle with removed bottom, and equipped with a stainless-steel wire spiral in a Teflon sleeve and a plastic mesh secured to the bottom of the bottle with Velcro strips; the spiral is intended to agitate and push peanut seeds up. 3, recycled H₂O₂. 4, glass beaker with a funnel for the collection of H₂O₂ droplets that are condensed in the reactor. 5, commercial fogger, charged with 2% H₂O₂. 6, plastic thermos with an aquarium water pump submersed into distilled water. 7, commercial chiller.

FIG. 22 shows a setup utilized for additional aeration of the seeds, and agitation of H₂O₂ for its efficient use. FIG. 22 shows a setup for additional aeration of the seeds, and agitation of H₂O₂ for its efficient use. 1, check valve to prevent possible liquid flow into the pump in a rare event of an electric power interruption. 2, pre-imbibed seeds incubated and aerated at room temperature. 3, regulated aquarium pump. 4, HPLC stainless-steel porous filter for inlet solvents.

FIG. 23 shows a fragment of a typical chromatogram of seed extract; seeds were treated with 3 portions of (new charge every 24 h) 3% H₂O₂ in a shaker for 72 h at 20° C. Peak 1, trans-resveratrol; 2, trans-viniferin; 5, trans-arachidin-1; 4, trans-arachidin-1. Peaks eluted before resveratrol, represent peanut phenolic acids, free amino acid phenylalanine, and traces of piceid. Concentration of resveratrol is 334 μg/g of dry weight. Georgia-06G seeds harvested in 2021. The peaks are represented by total light absorbance from 300 to 500 nm.

FIG. 24 shows a sample of blister-fried AUNPL-17 (2021 harvest) peanuts prepared by in-shaker incubation with 3% H₂O₂ at 20° C. for 48 h, followed by peanut oil frying for 5 min at 177° C.

FIG. 25 shows peanut seed fractions that are routinely obtained during common post-harvest commercial processing of peanut pods and that are suitable for boosting resveratrol concentrations in these seed fractions. 1, Sound Mature Kernels; 2, Sound Splits; 3, Damaged or Discolored; 4, #1 or Other Kernels; 5, Splits or Cracked/Broken; 6, Skins; 7, Oil Stock.

All peanut seed fractions, including 1, 2, 3, 4, 5, and 7 were used in the condition as they appear in FIG. 25 in all the experiments for boosting resveratrol concentrations in these seeds/seed parts. Skins 6 and embryos (not shown) were not separately treated with H₂O₂, but only when they were naturally attached to kernels. Most experiments were performed with Sound Mature Kernels (1) and #1 or Other Kernels (4) intended for human consumption as whole roasted kernels.

Edible is something that is suitable or safe to eat. The peanuts with increased resveratrol concentration described in various embodiments may be consumed raw, after processing before consumption such as washing, cooking by steaming, boiling, roasting, frying, microwaving, broiling and the like. Said peanut products may be coated, seasoned with suitable ingredients, preservatives, colors and other materials used in the food industry before consumption or packaging and storage for later use. Before practical application as food, products described need to be analyzed for further chemical composition, and sensory evaluations.

Damage, as defined and visualized in “Milled Peanuts. Inspection Instructions” (United States department of Agriculture, December 2020), is any injury or defect which materially affects the appearance, edible or shipping quality of the individual peanut or the lot as a whole. The USDA reference above describes the following guidelines which shall be considered as damage: (1) Cracked of broken shells which have been broken to the extent that the seed or kernel within is plainly visible without minute examination and with no application of pressure, or the appearance of the individual peanut is materially affected. (2) Discolored shells which have dark discoloration caused by mildew, staining, or other means affecting one-half or more of the shell surface. Talc powder or other similar material which may have been applied to the shells during the cleaning process shall not be removed to determine the amount of discoloration beneath, but the peanut shall be judged as it appears with the talc. (3) Kernels or seeds which are rancid or decayed. (4) Moldy kernels. (5) Kernels showing sprouts extending more than one-eighth inch from the end of the kernel. (7) Distinctly dirty kernels. (8) Kernels or seeds which are wormy, or have worm frass adhering, or have work cuts which are more than superficial. (9) Kernels or seeds which have dark yellow color penetrating the flesh, or yellow pitting extending deep into the kernel.

Incubation as described herein is the process of treatment of seeds over a period of time, with materials such as aqueous hydrogen peroxide at set a temperature or temperature gradients to produce increased concentrations of resveratrol. Incubation may be conducted in commercially available incubators that can shake or agitate incubating materials as and when needed.

Hydrogen peroxide solutions described here were prepared from 30% hydrogen peroxide, H₂O₂; Certified ACS grade commercially available and used in the art. The concentration of hydrogen peroxide solutions used is described in weight percent (wt %). Any other suitable source of hydrogen peroxide may be used in the practicing of the methods and compositions taught herein.

There are various ways to prepare hydrogen peroxide solutions of needed concentrations.

It is common to express the concentration of a solution by the percent of a solute (H₂O₂) in the solvent (water). The percent can further be determined by the ratio of the mass of the solute divided by the mass of the solution or by the ratio of the volume of the solute divided by the volume of the solution.

Mass percent: when the solute in a solution is a solid, a convenient way to express the concentration is by mass percent (mass/mass), which is the grams of solute per 100 g of solution. Here and throughout the text mass percent is interchangeable with weight percent.

Percent by mass=mass of solute÷mass of solution×100%.

Volume percent: the percentage of solute in a solution can more conveniently be determined by volume when the solute and solvent are both liquids, like H₂O₂ and water.

Percent by volume=volume of solute÷volume of solution×100%.

Percentage of commercial hydrogen peroxide supplied may be indicated on a label or in the Safety Data Sheet (SDS) as percent by mass or as percent by volume.

Some examples of the preparation of hydrogen peroxide solution of needed concentration are given below.

Example 1. Density of commercial 3% (prepared as weight/weight) aqueous solution of H₂O₂ is approximately 1.01 g/mL (at 20° C.; g/cm³=g/mL), which is very close to density of water, approximately 1.00 g/mL, (at 20° C.); therefore, calculations and dilutions may be made with negligeable errors using more practical volume/volume units. Concentrations of H₂O₂ of 0.05, 0.1, 1.0, and 2% can be prepared by diluting commercial 3% H₂O₂ with corresponding volumes of distilled H₂O₂. Table 1 gives examples of preparation of 300 mL H₂O₂ solutions from 3% H₂O₂.

TABLE 1

| Needed | Volume of 3% | Volume of water |
|---|---|---|
| concentration | H₂O₂ used for | used for |
| of H₂O₂ (%) | dilution (mL) | dilution (mL) |
| 0.05 | 5 | 295 |
| 0.1 | 10 | 290 |
| 1.0 | 100 | 200 |
| 2.0 | 200 | 100 |
| 3.0 | 300 | 0 |

Commercial hydrogen peroxide for household and medical use is commonly labeled as a 3% by volume solution. In this case, all ingredients for the dilution are measured as volumes.

Example 2. Density of commercial 30% (prepared as weight/weight) aqueous solution of H₂O₂ is approximately 1.11 g/mL (at 20° C.), which is about 11% higher than that of water. Therefore, for example, to prepare 300 mL of a 5% H₂O₂ solution from a 30% H₂O₂ solution, 45 mL [(1.00÷1.11)×50=45] of the 30% solution needs to be diluted with 255 mL of water (300−45=255). Table 2 gives examples of preparation of 300 mL H₂O₂ solutions from 30% H₂O₂.

TABLE 2

| Needed | Volume of 30% | Volume of water |
|---|---|---|
| concentration | H₂O₂ that needs | used for |
| of H₂O₂ (%) | to be diluted (mL) | dilution (mL) |
| 4 | 36 | 264 |
| 5 | 45 | 255 |
| 6 | 54 | 246 |
| 7 | 63 | 237 |
| 8 | 72 | 228 |

### Example 3

Dilution can be achieved by proportional mixing of the solute (H₂O₂) and solvent (water). This technique is convenient when larger volumes of sufficiently accurate concentrations of H₂O₂ are needed. The examples are given in Table 3.

TABLE 3

| Needed | Weight, g (volume, mL) | Volume of water |
|---|---|---|
| concentration | of 30% H₂O₂ that needs | used for |
| of H₂O₂ (%) | to be diluted | dilution (mL) |
| 0.05 | 1 (0.9) × k* | 599 × k |
| 0.1 | 1 (0.9) × k | 299 × k |
| 1.0 | 1 (0.9) × k | 29 × k |
| 2.0 | 1 (0.9) × k | 14 × k |
| 3.0 | 1 (0.9) × k | 9 × k |
| 4.0 | 1 (0.9) × k | 6.5 × k |
| 5.0 | 1 (0.9) × k | 5 × k |
| 6.0 | 1 (0.9) × k | 4 × k |
| 7.0 | 1 (0.9) × k | 3.29 × k |
| 8.0 | 1 (0.9) × k | 2.75 × k |

*k is a coefficient that can be chosen based on the needed volume of H₂O₂ of desired concentrations.

For example, to prepare 10 mL of 3% H₂O₂ solution from a 30% H₂O₂ solution, I part (by weight) of 30% solution need to be mixed with 9 parts (by weight or volume) of distilled water. To prepare approximately 300 mL of 3% H₂O₂ solution, 27 mL (0.9×30 mL) of 30% H₂O₂ solution need to be diluted with 270 mL. (9×30 mL) of water, which makes the total volume of 297 mL (27 mL+270 mL) of 3% H₂O₂.

As it is stated above, for most of the experiments described in the present disclosure, 30% hydrogen peroxide supplied by the Thermo Fisher Scientific (Fair Lawn, NJ) as 5 batches (5 4-liter bottles) with 3 different lot numbers were used. The labels on all the canisters listed 29.0% of H₂O₂ as the minimum concentration of the reagent. Safety Data Sheet (SDS) provided by the company (Revision Number: 12; Revision Date: Dec. 24, 2021) indicates 20-35 weight % of H₂O₂. The inventors, in their calculations assumed that the concentration of the reagent was 30% by weight. However, as it is evident from the SDS, the concentration of the reagent may vary around the declared value. In this case, overlapping concentrations of the diluted H₂O₂ used in the experiments may occur. For example, not only concentrations expressed by the whole numbers from 1.0 to 8.0%, but some concentrations between consecutive whole numbers presumably were tested and were demonstrated to be effective as resveratrol elicitors.

Hydration is a step to facilitate absorption of water by seeds to brake dormancy and to provide sufficient water activity for the essential physiological processes required for production of resveratrol. Hydration may be done with 0.05 or 0.1% H₂O₂, instead of water, to prevent potential bacterial growth in other embodiments.

Agitation is to put something into motion by shaking or stirring. Several types of agitation machines are known in the art used for agitation in the laboratory and on industrial scale.

Sonication is the act of applying sound energy to agitate particles in a sample. Disclosed herein for other embodiments of methods is the use of sonication at ultrasonic frequencies (>20 kHz).

“About” as used herein when referring to a measurable value such as an amount, a temporal duration, and the like, is meant to encompass variations of ±10%, in certain embodiments ±5%, in certain embodiments ±1%, in certain embodiments ±0.1% from the specified value, as such variations are appropriate to perform the disclosed methods.

Unless otherwise explained, all technical and scientific terms used herein have the same meaning as commonly understood by one of ordinary skill in the art to which this disclosure belongs. The singular terms “a”, “an”, and “the” include plural referents unless context clearly indicates otherwise. Similarly, the word “or” is intended to include “and” unless the context clearly indicates otherwise.

It is to be understood that wherever values and ranges are provided herein, all values and ranges encompassed by these values and ranges, are meant to be encompassed within the scope of the present disclosure. Moreover, all values that fall within these ranges, as well as the upper or lower limits of a range of values, are also contemplated by the present application.

Ranges: throughout this disclosure, various aspects of the disclosed subject matter can be presented in a range format. It should be understood that the description in range format is merely for convenience and brevity and should not be construed as an inflexible limitation on the scope of the disclosed subject matter. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range.

Various embodiments of the claims are shown and described herein. It will be obvious to those skilled in the art that such embodiments are provided by way of example only. Numerous variations, changes, and substitutions will occur to those skilled in the art without departing from the embodiments of claims. All publications, patents, and patent applications mentioned in this specification are herein incorporated by reference to the same extent as if each individual publication, patent, or patent application was specifically and individually indicated to be incorporated by reference.

### Examples

Plant Material: Seeds of three peanut genotypes were tested: Georgia-06G (popular runner-type cultivar) from the Peanut Foundation (Alexandria, VA) 2020 harvest; Georgia-06G from the National Peanut research Laboratory (NPRL), ARS, USDA, 2021 harvest; AUNPL-17 (high-oleic, runner-type cultivar) from NPRL, 2021 harvest; and Georgia-11J (Virginia-type cultivar) from NPRL, harvested in 2021. All of these genotypes are commercial bulk seeds that were not graded using a common shellers practice and were used as is except for manually removing split and heavily damaged seeds. Full and/or uniform maturity of seeds was not assured as well. All seeds were stored in plastic bags at 5+1° C. before using them in the experiments.

Hydration of Peanut Seeds and Treatment Procedures: Whole seeds were hydrated in 0.1% H₂O₂ at 20±1° C. for 16 h (hours) without light; the ratio of seeds to liquid was 1:4 (w/v); without delay, the hydrated seeds were used in the experiments described below.

In all incubation experiments, unless otherwise noticed, the temperature was 20° C.; concentrations of H₂O₂ were 2 or 3%; incubation time was from 24 to 72 h; samples were collected every 24 h (hours).

Static incubation: Appropriate amount of H₂O₂ was added to hydrated peanut seeds and placed into incubator without any agitation. In this experimental setup, the following parameters were systematically changed to optimize the production of resveratrol and to obtain satisfactory visual quality of seeds after roasting: seed hydration temperature from 4 to 30° C.; seed hydration time from 3 to 24 h (hours); seed hydration media, distilled water, 0.1% of H₂O₂; incubation temperature from 15 to 45° C.; incubation time from 12 to 96 h (hours); ratio of seeds to H₂O₂ from 1:3 to 1:20 (w/v), respectively; concentrations of hydrogen peroxide at the seed incubation step from 0.05 to 8% under neutral, basic (0.0375% solution of K₂CO₃ in 2% or 3% H₂O₂: pH=8.8), and acidic conditions (0.1% solution of CH₃COOH in 2% or 3% H₂O₂; pH=3.2); single load of hydrogen peroxide at the incubation step; periodic change of H₂O₂ with the same volume of fresh portions of the reagent.

Shaking: This experimental setup, as well as those described below, were used after the first optimization approach described above. Constant circular-motion shaking with 2.5 cm stroke was adjusted to 60-100 rpm.

Static fogging: A constant flow of H₂O₂ fog/mist was made available in a custom-made reactor with a small computer fan and a commercial fogger (FIG. 15).

Dynamic fogging: To supply a constant flow of H₂O₂ to avoid its exhaustion and to provide fogging with additional aeration and mechanical agitation by rotation of the reactor at 10 rpm, a modified rotary evaporator with custom-made reactors, a commercial fogger, a chiller, and a computer fan was used (FIG. 16).

Sonication. For sonication, peanut seeds were loaded into a 300-mL beaker with appropriate amount of H₂O₂ to bring the ratio of peanuts to liquid to 1:4 (w/v). The beaker was placed in an ultrasonic bath, which was filled with distilled water to the level matching the level of liquid in the beaker. The peanuts were sonicated for 2 min (minutes) every 60 min for 8 h (hours) followed by a 16 h pause. Sonication was performed up to 96 h with a periodic, 24 h change of H₂O₂ to fresh equal volumes of the reagent.

Aeration. This setup (FIG. 17) was utilized for additional aeration of the seeds, and agitation of H₂O₂ for its efficient use. The air flow rate for a 300 mL volume of H₂O₂ was 0.15-0.20 L/min; H₂O₂ was changed to fresh equal volumes of the reagent every 24 h; the ratio of seeds to H₂O₂ was from 1:6 to 1:9 (w/v) aka (weight/volume), respectively.

Preparation of control peanut seeds for “blister” frying. Triple amount of boiling distilled water was poured over peanut seeds in a Styrofoam container. The container was covered with a Styrofoam lid and left for 30 min. Then the water was decanted, and seeds were placed as a pile on a paper towel for 30 min followed by frying.

Drying, roasting, and frying peanut seeds. After incubation in H₂O₂, all seeds, except for those, that were intended for blister frying, were dried in a food dehydrator at 35° C. for 12-13 h to moisture levels of 6-9% followed by oven roasting at 177° C. for 12-15 min. Experimental and hydrated control peanut seeds were blister fried in commercial peanut oil at 177° C. for 5-8 min followed by scooping the seeds and bringing them to room temperature as a monolayer on a thick paper towel. An example of blister-fried AUNPL-17 (2021 harvest) peanuts is shown in FIG. 5. Dry seeds-dry peanut seeds are considered dry (and safe to store), when moisture level is 10%

Reagents, Materials, and Basic Apparatus: HPLC-grade organic solvents used in the preparation of the mobile phase were obtained from Thermo Fisher (Suwanee, GA). HPLC-grade H₂O was prepared with a ZD20 four-bowl Milli-Q water system (Millipore). HPLC-grade methanol used for seed extraction, hydrogen peroxide (30% H₂O₂; Certified ACS; Thermo Fisher Scientific, Fair Lawn, NJ), ACS grade K₂CO₃, glacical CH₃COOH, and Fast Blue B salt were purchased from Fisher. A model #AUV20AWHT 1.25 L capacity AirCare Aurora Ultrasonic Humidifier was purchased from W. S. Jenks & Son (Washington, DC). A model #EC4020M12C 40×40×20 mm fan was purchased from Evercool Thermal Co., Ltd. (Newegg, City of Industry, CA). A model E25 shaker incubator New Brunswick Excella was purchased from Eppendorf (Thermo Fisher Scientific, Inc.; Pittsburgh, PA) and a model T-9 Transistor/Ultrasonic bath with a power density of 33.5 mW/cm3 was purchase from L&R (Kearny, NJ). A 750 W, stock #06301, Presto electric food dehydrator was purchased from National Presto Industries, Inc. (China). A model AB15 Accumet basic pH meter with calibrating solutions was purchased from Fisher Scientific, and a model #561-00000-01-0 Hei-VAP Advantage rotary evaporator was purchased from Heidolph North America (Wood Dale, IL). A model CTR-160P Single Kernel Moisture Tester was purchased from Shizuoka Seiki Co., Ltd. (Fukuroi, Shizuoka-ken, Japan). An aquarium Tetra Luft Pump (Tetra/Second nature; Blacksburg, VA) was purchased locally.

Reference Compounds. Standards of trans-resveratrol (1) (99% declared purity) and trans-piceid (polydatin; 3,5,4′-Trihydroxystilbene-3-O-β-D-glucopyranoside) (3) were purchased from Sigma. Individual stilbenoids, trans-arachidin-3 (4), trans-arachidin-1 (5), and trans-3′-isopentadienyl-3,5,4′-trihydroxystilbene (IPD) (8) (FIG. 1) were obtained as described (Sobolev et al., J. AOAC Int. 1995, 78, 1177-1182), except that preparative HPLC was used as a final purification step rather than preparative TLC. Based on area percent, purity of arachidin-3, arachidin-1, and IPD were 99.2, 98.1, and 92.0% at 334, 340, and 296 nm, respectively. HPLC separation was achieved by using isocratic mobile phase 3. Arahypin-5 (6) was obtained through a procedure described (Sobolev et al. J. Agric. Food Chem. 2009, 57, 62-68.); its purity was estimated at 95.5% (area percent at 340 nm). Arahypin-7 (7) was made available as described (Sobolev et al. J. Agric. Food Chem. 2010, 58, 875-881.); its purity was estimated at 96.8% (area percent at 347 nm).

Extraction Technique. Dried/oven-roasted/oil-fried seeds were processed as whole seeds, or they were manually separated into skins, cotyledons, and embryonic axes. For simplicity of presentation “embryo” is used instead of “embryonic axis”.

Prepared samples were immediately used for further analyses or kept frozen at −28° C. up to 7 days. To extract resveratrol and its derivatives from 4 pre-weighed unroasted or roasted cotyledons, double amount (vol/wt.) of 90% MeOH was added to each vial, and the sample was pulverized in a reinforced 2-ml or 7-ml vial at 5.5 m/see with the help of 2.8-mm ceramic beads in an Omni Bead Raptor 24 (all from Omni International, Inc., Kennesaw, GA) for 30 s at the 5.5 m/see setting. Six or 12 beads were used in 2-ml or 7-ml vials, respectively. Then the vials were centrifuged in a Corning model 6765 LSE Compact Centrifuge (Fisher Scientific) for 3 min at 4000 rpm, and the supernatant was filtered through a Pasteur pipet with a glass-fiber plug firmly placed in its tip into a Thermo screw thread autosampler vial (catalog #03-375-CA) with a matching cap (catalog #03-397-05). Embryos or skins separated from 2 seeds, were precisely weighed, and placed into 2-ml vials followed by addition of 0.5 mL of 90% MeOH; the same volume of the solvent was used for all samples regardless of the sample weight. Then the samples were processed as described above for cotyledons.

HPLC-DAD-MS Analyses. Separations of seed extracts were performed using a tandem HPLC-MS Vanquish HPLC system equipped with a model FT Split Sampler autosampler, a model F Quaternary Pump, a model FT Diode Array Detector (DAD), and an Xselect HSS 100×4.6 mm i.d., 3.5 μm C18 analytical column (all from Thermo Scientific). H2O (A) and MeOH (B) were used in the following gradient: initial conditions, 50% A/50% B, changed linearly to 20% A/80% B in 6.0 min, changed to 1% A/99% B in 6.01 min, held isocratic for 3.4 min, then changed to initial conditions in 0.01 min and held isocratic for 1.8 min before next injection. The flow rate was 1.2 mL/min. The column was maintained at 40° C.

MS analyses were performed using a Thermo Scientific LTQ XL ion trap mass spectrometer equipped with an ESI interface and operated with Xcalibur version 4.2.47 software (Thermo Electron Corporation, San Jose, CA). The data were acquired in the full-scan mode (MS) from m/z 100 to 2000. Heated capillary temperature was 230° C., APCI vaporizer temperature 330° C., sheath gas flow 50 units, auxiliary gas flow 7 units, capillary voltage 35 V, and source voltage 4.5 kV. In MS2 analyses, the [M+H]⁺ or [M−H]⁻ ions observed for each chromatographic peak in full-scan analyses were isolated and subjected to source collision-induced dissociation (CID) using He buffer gas. In all CID analyses, the isolation width, relative fragmentation energy, relative activation Q, and activation time were: 1.0, 20 to 33%, 0.25 and 30 msec, respectively. Concentrations of trans-resveratrol, trans-arachidin-1, trans-arachidin-3, trans-3′-isopentadienyl-3,5,4′-trihydroxystilbene, and trans-piceid in the extracts were determined by reference to peak areas of corresponding pure standards at 307, 340, 335, 296, and 307 nm, respectively. The identity of trans-δ-viniferin was assured by matching its MS-MS spectra in positive and negative ionization modes, as well as its UV spectrum, with published data (Pezet et al., J. Agric. Food Chem. 2003, 51, 5488-5492; Jerkovic et al., RCM. 2007, 21, 2456-2466). Concentrations of viniferin were determined based on its molar extinction coefficient at 307 nm (Pezet et al., J. Agric. Food Chem. 2003, 51, 5488-5492).

Data Analysis. Statistical difference among treatment groups was determined by one-way analysis of variance (ANOVA) followed by the Tukey test for comparison between different groups. A difference was considered statistically significant at P<0.05. Analyses were performed with R version 4.1.1 (R Development Core Team, 2021).

We claim:

1. A method for increasing resveratrol in peanut seeds, the method comprising incubating harvested hydrated peanut seeds for at least 12 hours in aqueous hydrogen peroxide (H₂O₂).

2. The method of claim 1, wherein the H₂O₂ concentration is less than about 8 weight percent (8%).

3. The method of claim 1, wherein after incubation, and drying, the amount of resveratrol in the peanut seeds is at least about 50 μg resveratrol per g of dry seeds.

4. The method of claim 1 where a 1-4 weight percent hydrogen peroxide solution is employed.

5. The method of claim 2 where the medium is slowly agitated.

6. The method of claim 1 where the peanut seeds are hydrated in a hydration media selected from water or 0.1 weight percent aqueous hydrogen peroxide (H₂O₂).

7. The method of claim 1 where the seeds are incubated in a neutral, basic, or acidic medium H₂O₂ solution.

8. The method of claim 7 where the medium is basic with pH of 7.5 to 11.5 or acidic with pH 2 to 6.9 in a 1-4 weight percent a hydrogen peroxide solution.

9. The method of claim 1 where the ratio of seeds to hydrogen peroxide solution is from 1:3 to 1:20 (w/v), respectively.

10. The method of claim 1 where a single load of hydrogen peroxide is employed for incubation, or a hydrogen peroxide solution is added to maintain a constant concentration in an incubation medium.

11. The method of claim 1 of air-drying the incubated seeds for 12-15 hours.

12. A method of increasing resveratrol concentration in peanut seeds comprising the incubation with a liquid or mist of aqueous hydrogen peroxide for at least 12 hours.

13. The method of claim 12 where the peanut seeds are hydrated in water or aqueous 0.1% aqueous hydrogen peroxide before incubation.

14. The method of claim 12 where the concentration of H₂O₂ is less than 8%.

15. The method of claim 12 where the incubation is with agitation, sonication, or aeration.

16. The method of claim 12 wherein the peanut seeds are not size reduced or visually showing damage to the embryo or cotyledons. A resveratrol-enriched peanut seed wherein the resveratrol concentration is at least 50 micrograms/gram.

17. The peanut seed of claim 16 with a resveratrol concentration of at least 100 micrograms/gram.

18. The peanut seed of claim 16 with a resveratrol concentration of at least 200 micrograms/gram.

19. The peanut seed of claim 16 not size reduced or visually showing no damage to the embryo or cotyledons.

20. A whole resveratrol-enriched peanut seed with at least about 50 μg resveratrol per g of dry seed.

21. The peanut seed of claim 20 not size reduced or visually showing no damage to the embryo or cotyledons.

22. A whole resveratrol-enriched peanut seed with at least about 150 μg resveratrol per g of dry seed.

23. The peanut seed of claim 22 not size reduced or visually showing no damage to the embryo or cotyledons.

24. The peanut seed of claim 22 with at least about 250 μg resveratrol per g of dry seed, not size reduced or visually showing no damage to the embryo or cotyledons.

25. The peanut seed of claim 22 with at least about 300 μg resveratrol per g of dry seed, not size reduced or visually showing no damage to the embryo or cotyledons.

26. The peanut seed of claim 22 with at least about 500 μg resveratrol per g of dry seed, not size reduced or visually showing no damage to the embryo or cotyledons.
